(19) United States
(12) Patent Application Publication
(10) Pub. No.: US 2005/0076729 A1
(43) Pub. Date: Apr. 14, 2005

(54) Eccentric wheel unit with a distance adjuster

(75) Inventor: Chia-Ming Hsieh, Ping Tung Hsien (TW)

Correspondence Address: Ladas & Parry, 26 West 61st Street, New York, NY, 10023, US

(73) Assignee: BENQ CORPORATION

(21) Appl. No.: 11/005,362

(22) Filed: Dec. 6, 2004

(30) Foreign Application Priority Data
Oct. 12, 2003 (TW) 92134887

(51) Int. Cl. F16H 21/16

(52) U.S. Cl. 74/25

(57) ABSTRACT

An eccentric wheel unit includes a driven shaft; a rotary arm having a first end perpendicularly fixed to the driven shaft; an eccentric hammer member defining a mass center which is spaced apart from the driven shaft about a predetermined distance; and a distance adjuster mounted within the eccentric hammer member for varying the predetermined distance. The distance adjuster has a first side connected to a second end of the rotary arm. When the driven shaft rotates, the rotary arm rotates and moves the distance adjuster to cause the mass center to move away from the driven shaft.

### FIELD OF THE INVENTION

The present invention relates to an eccentric wheel unit, specifically to an eccentric wheel unit of an apparatus that is adapted to be driven by a motor and that has a distance adjuster so that the torque for driving the eccentric wheel unit can be varied.

### BACKGROUND OF THE INVENTION

In some apparatus, such as a massage apparatus, vibration is conducted through a motor. Office staffs generally use the massage apparatus for muscle relaxation. The vibration performs the tapping, kneading and rubbing actions. Some selectors, such as grain selector, uses a motor to vibrate particular items, like minerals or stones, in order to select a specific grade of the items. In addition, in the telecommunication field, a motor can be employed in a cellular phone so as to cause the vibration thereof.

Referring to FIG. 1, a conventional vibration unit 2 is shown to include a motor 6 and an eccentric wheel member 4. The eccentric wheel member 4 includes a driven shaft 402 having a first end fixed co-axially on an output shaft of the motor 6 so as to be driven upon actuation thereof, and an eccentric hammer 404 fixed on the other end of the driven shaft 402. The eccentric hammer 404 defines a mass center which is not on the driven shaft 402 and which is spaced apart from an axis of the output shaft of the motor 6 by a fixed distance. When the motor 6 is actuated, the driven shaft 402 rotates to cause the eccentric hammer 404 to vibrate so as to provide actions, like tapping and massaging effects. As is known in the art, the motor 6 requires a larger torque to rotate the eccentric hammer 404 via the driven shaft 402 at the start. Current of predetermined amount is allowed to flow into the motor 6 in order to actuate the same. Since the mass center of the eccentric hammer 404 relative to the axis of the motor 6 remains the fixed distance, the torque required to begin rotation of the eccentric hammer 404 and the torque required to keep the eccentric hammer 404 in motion will not be the same. Once the eccentric hammer 404 is in motion, and in case the mass center of the eccentric hammer 404 can be moved away from the axis of the output shaft of the motor 6, the torque for rotating the eccentric hammer 404 will be enlarged. In other words, flows of current into the motor 6 so as to activate the same can be controlled in order to economize the power source.

### SUMMARY OF THE INVENTION

The object of the present invention is to provide an eccentric wheel unit of an apparatus that is adapted to be driven by a motor and that has a distance adjuster so that the torque for driving the eccentric wheel unit at the beginning and in motion can be varied.

An eccentric wheel unit according to the present invention is used in an apparatus and includes: a driven shaft; a rotary arm having a first end and a second end, the first end being perpendicularly fixed to the driven shaft; an eccentric hammer member defining a mass center which is spaced apart from the driven shaft about a predetermined distance; and a distance adjuster mounted within the eccentric hammer member for varying the predetermined distance, and having a first side connected to the second end of the rotary arm, wherein when the driven shaft is rotated, the rotary arm rotates and moves the distance adjuster to cause the mass center to move away from the driven shaft.

### BRIEF DESCRIPTION OF THE DRAWINGS

The foregoing aspects and many of the attendant advantages of this invention will become more readily appreciated as the same *becomes better understood by reference to the following detailed description, when taken in conjunction with the accompanying drawings, wherein:

FIG. 1 is a perspective view of a conventional eccentric wheel unit connected to a motor;

FIG. 2 is a fragmentary perspective view of the first preferred embodiment of an eccentric wheel unit according to the present invention when driven by a motor;

FIG. 3 is a fragmentary sectional view the second preferred embodiment of an eccentric wheel unit according to the present invention when driven by a motor;

FIG. 4 is a fragmentary sectional view the third preferred embodiment of an eccentric wheel unit according to the present invention when driven by a motor;

FIG. 5 is a fragmentary sectional view the fourth preferred embodiment of an eccentric wheel unit according to the present invention when driven by a motor;

FIG. 6 is a fragmentary sectional view the fifth preferred embodiment of an eccentric wheel unit according to the present invention when driven by a motor; and

FIG. 7 is a fragmentary sectional view the sixth preferred embodiment of an eccentric wheel unit according to the present invention when driven by a motor;

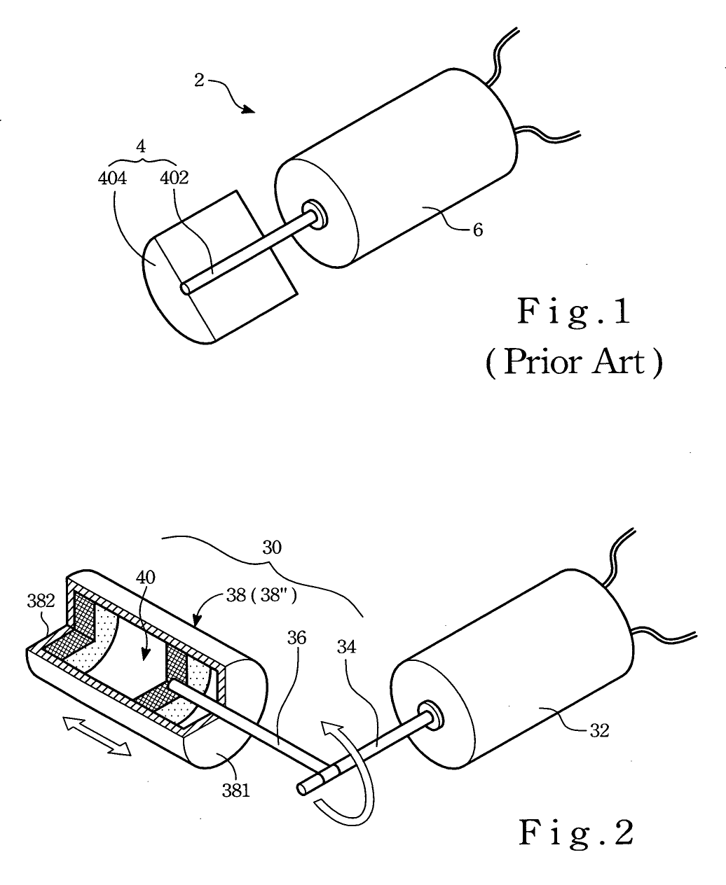

### DETAILED DESCRIPTION OF THE PREFERRED EMBODIMENTS

Before the present invention is described in greater detail with reference to the following preferred embodiments, it should be noted that same reference numerals have been used to denote similar elements throughout the specification.

Referring to FIG. 2, the first preferred embodiment of an eccentric wheel unit 30 for an apparatus according to the present invention is shown to include a driven shaft 34, a rotary arm 36, an eccentric hammer member 38, and a distance adjuster 40.

As illustrated, the driven shaft 34 is connected co-axially to an output shaft of the motor 32 so as to be driven thereby.

The rotary arm 36 has a first end perpendicularly fixed to the driven shaft 34 and a second end opposite to the first end.

The eccentric hammer member 38 defines a mass center which is spaced apart from the driven shaft 34 about a predetermined distance.

The distance adjuster 40 is mounted movably within the eccentric hammer member 38 for varying the predetermined distance, and has a first side connected to the second end of the rotary arm 36. When the driven shaft 34 is rotated by virtue of actuation of the motor 32, the rotary arm 36 rotates and moves the distance adjuster 40 to cause the mass center to move away from the driven shaft 34. When the driven shaft 34 is stopped from rotation, the distance adjuster 40 causes the mass center to move toward an axis of the driven shaft 34.

In the first preferred embodiment, the eccentric hammer member 38 includes a hollow body 38″ that has a first sidewall 381 formed with an opening. The distance adjuster 40 is mounted movably within the hollow body 38″. The second end of the rotary arm 36 extends into the hollow body 38″ via the opening so as to connect the distance adjuster 40.

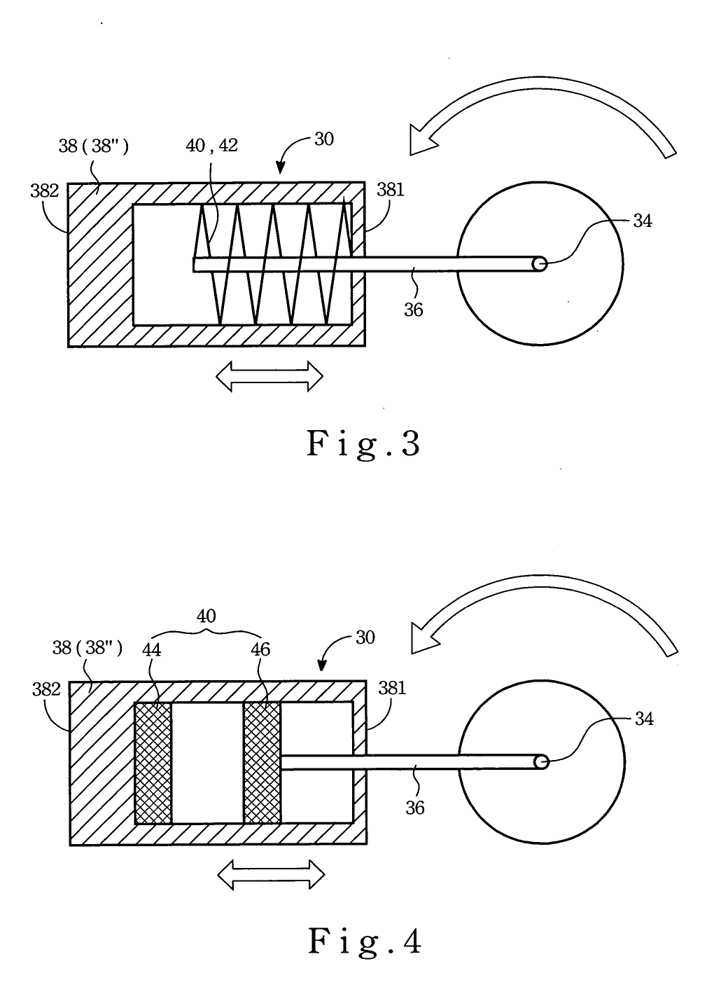

Referring to FIG. 3, the second preferred embodiment of an eccentric wheel unit 30 according to the present invention is shown to be similar to the first preferred embodiment in construction, except that the distance adjuster 40 includes a coil spring 42. The coil spring 42 has a first end connected to the first sidewall 381 of the hollow body 38″, and a second end connected to the second end of the rotary arm 36 in such a manner that a centrifugal force resulting from rotation of the rotary arm 36 depresses the coil spring 42 and reduces a total length of the coil spring 42, thereby disposing the mass center away from an axis of the driven shaft 34.

Referring to FIG. 4, the third preferred embodiment of an eccentric wheel unit 30 according to the present invention is shown to be similar to the first preferred embodiment in construction. The only difference resides in that the distance adjuster 40 includes first and second magnetic pieces 44,46. The first magnetic piece 44 is mounted on a second sidewall 382 of the hollow body 38″ opposite to the first sidewall 381. The second magnetic piece 46 is disposed in the hollow body 38″ and is further fixed to the second end of the rotary arm 36. Adjacent sides of the first and second magnetic pieces 44,46 define two opposite poles so as to create a magnetic attracting force therebetween. Under this condition, the magnetic attracting force between the first and second magnetic pieces 44,46 is compensated by a centrifugal force resulting from rotation of the rotary arm 36. The centrifugal force causes the mass center away from an axis of the driven shaft 34.

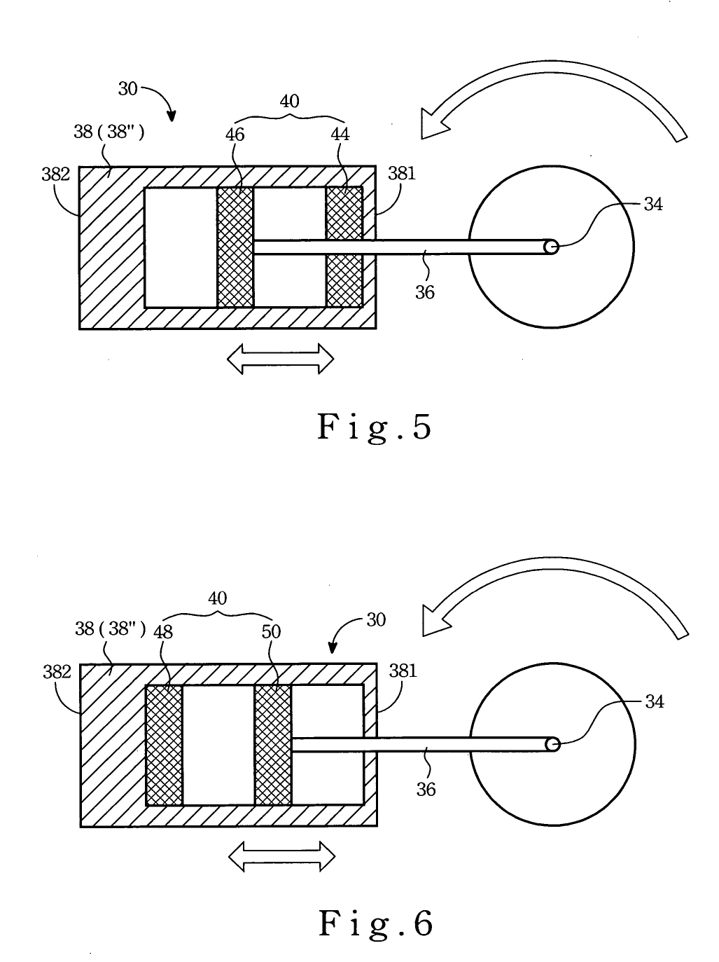

Referring to FIG. 5, the fourth preferred embodiment of an eccentric wheel unit 30 according to the present invention is shown to be similar to the first preferred embodiment in construction. The main difference resides in that the distance adjuster 40 includes first and second magnetic pieces 44,46. The first magnetic piece 44 is mounted on a second sidewall 382 of the hollow body 38″ opposite to the first sidewall 381. The second magnetic piece 46 is disposed in the hollow body 38″ and is further fixed to the second end of the rotary arm 36. Adjacent sides of the first and second magnetic pieces 44, 46 define two identical poles so as to create a magnetic expelling force therebetween such that the magnetic expelling force between the first and second magnetic pieces 44, 46 is compensated by a centrifugal force resulting from rotation of the rotary arm 36 so as to result in reduction of distance between the first and second magnetic pieces 44,46. The reduced distance between the first and second magnetic pieces 44, 46 causes the mass center away from an axis of the driven shaft 34.

Referring to FIG. 6, the fifth preferred embodiment of an eccentric wheel unit 30 according to the present invention is shown to be similar to the first preferred embodiment in construction. The main difference resides in that the distance adjuster 40 includes a magnetic piece 48 and a metal piece 50. The magnetic piece. 48 is disposed within the hollow body 38″ and is mounted on a second sidewall 382 opposite to the first sidewall 381 having the opening. The metal piece 50 is disposed in the hollow body 38″ and is further mounted on the second end of the rotary arm 36. Adjacent sides of the magnetic piece 48 and the metal piece 50 define two different poles so as to create a magnetic attracting force therebetween. The magnetic attracting force between the magnetic piece 48 and the metal piece 50 is compensated by a centrifugal force resulting from rotation of the rotary arm 36, which in turn, causes increase in distance between the magnetic piece 48 and the metal piece 50, thereby disposing the mass center away from an axis of the driven shaft 34.

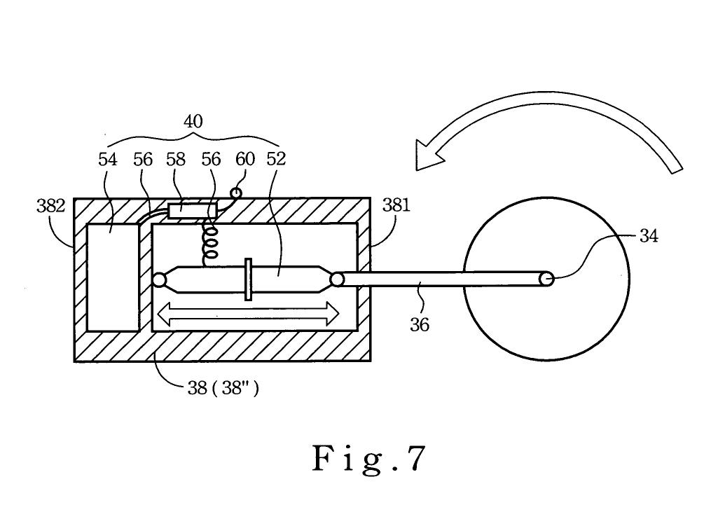

Referring to FIG. 7, the sixth preferred embodiment of an eccentric wheel unit 30 according to the present invention is shown to be similar to the first preferred embodiment in construction. The main difference resides in that the distance adjuster 40 includes a hydraulic cylinder device 52, a reservoir 54 for storing fluid therein, a pump unit 58, two fluid connector tubes 56, and a sensor 60. The hydraulic cylinder device 52 has one end connected to the second end of the rotary arm 36, and the other end connected to a second sidewall of the hollow body 38″ opposite to the first sidewall having the opening. When fluid flows into the hydraulic cylinder device 52, a total length thereof is increased. When fluid flows out from the hydraulic cylinder device 52, a total length thereof is reduced. The pump unit 58 provides a force for pumping fluid from the reservoir 54 into the hydraulic cylinder device 52 and vice versa. The fluid connector tubes 56 interconnect the reservoir 54 and the hydraulic cylinder device 52. The sensor 60 is electrically connected to the pump unit 58 for detecting angular rotation of the rotary arm 36. The sensor 60 activates the pump unit 58 upon detecting a large angular rotation of the rotary arm 36 so as to permit fluid flow from the reservoir 54 into the hydraulic cylinder device 52 via the fluid connector tubes 56, thereby expanding a total length of the hydraulic cylinder device 52, which in turn, dispose the mass center away from an axis of the driven shaft 34. In the similar manner, the sensor 60 de-activates the pump unit 58 upon detecting a small angular rotation of the rotary arm 36 so as to permit fluid flow from the hydraulic cylinder device 52 into the reservoir 54, thereby reducing a total length of the hydraulic cylinder device 52, which in turn, causes reduction in distance of the mass center relative to an axis of the driven shaft 34.

By virtue of the distance adjuster 40 in the eccentric wheel unit 30 of the present invention, the required amount of current to activate the motor (hence the driven shaft 34) can be varied. The eccentric hammer member 38 can retain a high torque once it is in motion.

As is understood by a person skilled in the art, the foregoing preferred embodiment of the present invention is an illustration of the present invention rather than limiting thereon. It is intended to cover various modifications and similar arrangements included within the spirit and scope of the appended claims, the scope of which should be accorded the broadest interpretation so as to encompass all such modifications and similar structure.

1. An eccentric wheel unit comprising:
a driven shaft;
a rotary arm having a first end and a second end, said first end being perpendicularly fixed to said driven shaft;
an eccentric hammer member defining a mass center which is spaced apart from said driven shaft about a predetermined distance; and
a distance adjuster mounted within said eccentric hammer member for varying said predetermined distance, and having a first side connected to said second end of said rotary arm, wherein when said driven shaft is rotated, said rotary arm rotates and moves said distance adjuster to cause said mass center to move away from said driven shaft.

2. The eccentric wheel unit according to claim 1, wherein when said driven shaft is stopped from rotation, said distance adjuster causes said center mass of said eccentric hammer member to move toward said driven shaft.

3. The eccentric wheel unit according to claim 1, wherein said eccentric hammer member includes a hollow body having a first sidewall formed with an opening, said second end of said rotary arm extending into said hollow body via said opening, said distance adjuster being mounted within said hollow body.

4. The eccentric wheel unit according to claim 3, wherein said distance adjuster includes a coil spring having a first end connected to said first sidewall of said hollow body, and a second end connected to said second end of said rotary arm, wherein a centrifugal force resulting from rotation of said rotary arm depresses said coil spring so as to reduce a total length of said coil spring and so as to dispose said mass center away from an axis of said driven shaft.

5. The eccentric wheel unit according to claim 3, wherein said distance adjuster includes first and second magnetic pieces, said first magnetic piece being mounted on a second sidewall of said hollow body opposite to said first sidewall having said opening, said second magnetic piece being disposed in said hollow body and being fixed to said second end of said rotary arm, wherein a magnetic attracting force between said first and second magnetic pieces is compensated by a centrifugal force resulting from rotation of said rotary arm, which in turn, causes said mass center away from an axis of said driven shaft.

6. The eccentric wheel unit according to claim 3, wherein said distance adjuster includes a first magnetic piece mounted on a second sidewall of said hollow body opposite to said first sidewall having said opening, a second magnetic piece being disposed in said hollow body and being fixed to said second end of said rotary arm, adjacent sides of said first and second magnetic pieces defining two different poles so as to create a magnetic attracting force therebetween, wherein the magnetic attracting force between said first and second magnetic pieces is compensated by a centrifugal force resulting from rotation of said rotary arm, which in turn, causes increase in distance between said first and second magnetic pieces, which in turn, causes said mass center away from an axis of said driven shaft.

7. The eccentric wheel unit according to claim 3, wherein said distance adjuster includes a magnetic piece disposed within said hollow body and mounted on a second sidewall of said hollow body opposite to said first sidewall having said opening, a metal piece disposed in said hollow body and mounted on said second end of said rotary arm, adjacent sides of said magnetic piece and said metal piece defining two identical poles so as to create a magnetic expelling force therebetween, wherein the magnetic expelling force between said magnetic piece and said metal piece is compensated by a centrifugal force resulting from rotation of said rotary arm, which in turn, causes reduction of distance between said magnetic piece and said metal piece, which in turn, causes said c mass center away from an axis of said driven shaft.

8. The eccentric wheel unit according to claim 3, wherein said distance adjuster includes:
a hydraulic cylinder device having one end connected to said second end of said rotary arm, and the other end connected to a second sidewall of said hollow body opposite to said first sidewall having said opening, wherein when fluid flows into said hydraulic cylinder device, a total length of said hydraulic cylinder device is increased, whererin when fluid flows out from said hydraulic cylinder device, a total length of said hydraulic cylinder device is reduced;
a reservoir for storing fluid therein;
a pump unit providing a force for pumping fluid from said reservoir into said hydraulic cylinder device and vice versa;
a fluid connector tube interconnecting said reservoir and said hydraulic cylinder device; and
a sensor for detecting angular rotation of said rotary arm, wherein said sensor activates said pump unit upon detecting a large angular rotation of said rotary arm so as to permit fluid flow from said reservoir into said hydraulic cylinder device via said fluid connector tube, thereby expanding a total length of said hydraulic cylinder device, which in turn, dispose said mass center away from an axis of said driven shaft, wherein said sensor de-activates said pump unit upon detecting a small angular rotation of said rotary arm so as to permit fluid flow from said hydraulic cylinder device into said reservoir, thereby reducing a total length of said hydraulic cylinder device, which in turn, causes reduction in distance of said mass center relative to an axis of said driven shaft.
